(19) United States
(12) Patent Application Publication
(10) Pub. No.: US 2026/0064368 A1
(43) Pub. Date: Mar. 5, 2026

(54) LINEAR AND PROBABILISTIC LOGARITHMIC COUNTER

(71) Applicant: Hewlett Packard Enterprise Development LP, Spring, TX (US)

(72) Inventors: James D. Regan, Fort Collins, CO (US); Salma Afifi, Fort Collins, CO (US); Gregg Bernard Lesartre, Fort Collins, CO (US)

(21) Appl. No.: 18/816,936

(22) Filed: Aug. 27, 2024

(51) Int. Cl. G06F 7/58

(52) U.S. Cl. CPC G06F 7/584; G06F 2207/581

(57) ABSTRACT

One aspect provides a dual-scale counter circuit that includes a counter logic unit to store a current counter value, a range-determination logic unit to determine an operating range of the dual-scale counter circuit based on the current counter value and a predetermined threshold value, and a counter-increment logic unit. The counter-increment logic unit is to increment the current counter value linearly for an increment event in response to the dual-scale counter circuit operating in a linear range and increment the current counter value probabilistically for the increment event in response to the dual-scale counter circuit operating in a probabilistic range. The dual-scale counter circuit further includes a linear-feedback shift register to generate a random binary bit sequence, based on which the counter-increment logic unit is to determine whether to increase the current counter value for the increment event when the dual-scale counter circuit operates in the probabilistic range.

### STATEMENT OF GOVERNMENT-FUNDING CLAUSE

This invention was made with Government support under Contract Number H98230-23-C-0350 awarded by the Maryland Procurement Office. The Government has certain rights in this invention.

### BACKGROUND

### Field

This disclosure is generally related to the design of counters. More specifically, this disclosure is related to the design of a dual-scale counter that counts small numbers accurately and large numbers approximately.

### BRIEF DESCRIPTION OF THE FIGURES

FIG. 1 illustrates the increment probability of different count value ranges, according to one aspect of the instant application.

FIG. 2 illustrates an example of the count value ranges, according to one aspect of the instant application.

FIG. 3 illustrates the block diagram of an example dual-scale counter, according to one aspect of the instant application.

FIG. 4 presents a flowchart illustrating an example process for incrementing a dual-scale counter, according to one aspect of the instant application.

FIG. 5 illustrates a computer system that facilitates the operation of a dual-scale counter, according to one aspect of the instant application.

FIG. 6 illustrates a computer-readable medium that facilitates the operation of a dual-scale counter, according to one aspect of the instant application.

In the figures, like reference numerals refer to the same figure elements.

### DETAILED DESCRIPTION

Aspects of the instant application provide a solution to the problem of reducing the chip area occupied by counters. More specifically, a dual-scale counter with a much smaller footprint than linear counters is described. The dual-scale counter can count small numbers accurately (e.g., increment linearly) and large numbers approximately (e.g., increment probabilistically).

Silicon chip area is often a concern in the design of computer systems since greater chip area increases the part cost of the entire system by reducing the number of chips that can be built on a silicon wafer. Moreover, a larger chip area may lead to a lower yield because the larger chip area includes more transistors and, hence, a greater chance of encountering a defective transistor. Chip designers often have a high incentive to reduce the chip area occupied by each device in order to reduce the part cost.

Counter circuits are essential components in network devices. For example, a switch application-specific standard product (ASIC) may include multiple counters for debugging and network telemetry purposes. When a network device is in service, the counters can collect data on network traffic, bandwidth usage, latency, packet loss, and other performance metrics. The telemetry data can be used to identify congestion in the network and is highly valuable to network administrators and architects. However, counter circuits are area-intensive, especially those counting large numbers. Reducing the chip area consumed by counter circuits may reduce the overall part cost of the network device.

Counters using an approximate counting algorithm typically occupy smaller chip areas (e.g., by reducing the number of bits needed to record the counter value). However, approximate counting is only suitable for large count values and may introduce unacceptable inaccuracy when counting small numbers. Some counter applications (e.g., telemetry data collection) require accurate counts at low count values but may tolerate less accurate counters at high count values. For example, when the count values are high (e.g., when counting the number of packets arrived at a port), it is sufficient to track the magnitude of the values. To take advantage of the relaxed accuracy requirements at large count values without sacrificing accuracy at small count values, aspects of this disclosure provide a dual-scale counter that can count small numbers accurately and large numbers approximately.

According to some aspects, the count values can be divided into a linear range and a probabilistic range. When the count values are below a predetermined threshold, the counter may be configured to count linearly (i.e., the change in the counter value is directly proportional to the number of events being counted). In other words, the likelihood of an increment in the counter value is one for each occurrence of the event. An occurrence of the event being counted may also be referred to as an increment event. In the example of counting packets arriving at a port, the counter value may increase by a fixed number (e.g., one or two) for each packet.

When the occurrences of the event are above the predetermined threshold (i.e., in the probabilistic range), the counter may be configured to count approximately, meaning that an occurrence of the event may not increment the counter value. In some examples, the likelihood of the increment in the counter value may decrease linearly on a logarithmic scale (e.g., a logarithmic scale of base 2). According to further aspects, the probabilistic range may be divided into a plurality of sub-ranges (e.g., n sub-ranges) based on the count values, each sub-range corresponding to a particular increment probability. The larger the count value, the lower the increment probability (i.e., the less likely an increment event results in the increment of the counter value). In some examples, the increment probability in the iₜₕ sub-range of the probabilistic range may be 2⁻ⁱ., where i is a positive integer representing the index of the sub-range. In alternative examples, the increment probability in the iₜₕ sub-range may be 10⁻ⁱ.

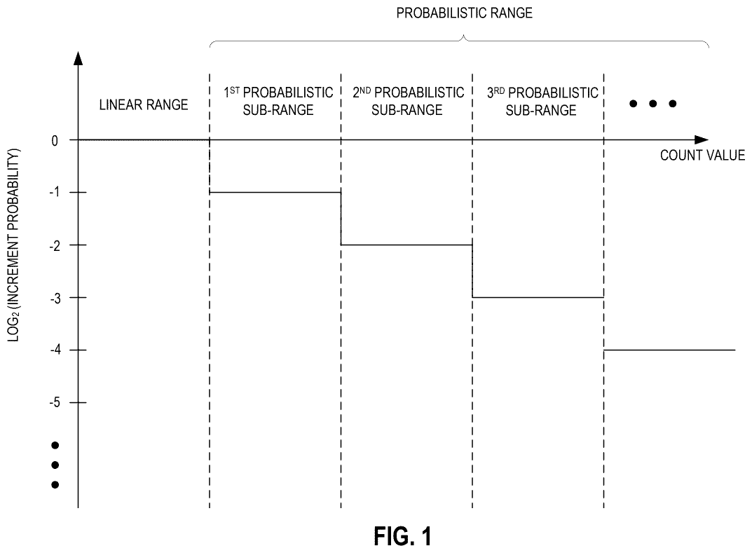

FIG. 1 illustrates the increment probability of different count value ranges, according to one aspect of the instant application. The horizontal axis represents the count value, starting from zero. The count values may be divided into a linear range and a probabilistic range. Low count values belong to the linear range. As the count value increases, it may exceed the linear range into the probabilistic range, which may be further divided into a plurality of sub-ranges. For example, as the count value increases to exit the linear range, it may fall within the first probabilistic sub-range, the second probabilistic sub-range, and so on. The vertical axis represents the increment probability in each range/sub-range. More specifically, the vertical axis is drawn in the logarithm scale of base 2. As shown in FIG. 1, the increment probability is 1 in the linear range, meaning that the counter increments by a fixed value each time an increment event is detected. On the other hand, the increment probability is less than 1 in the probabilistic range, meaning that there is a non-zero probability that the counter does not increment for a detected increment event. The increment probability varies for the different sub-ranges. In the example shown in FIG. 1, in the first probabilistic sub-range, the increment probability is 2⁻¹ (or ½); in the second probabilistic sub-range, the increment probability is 2⁻² (or ¼); and so on. In this example, the increment probability decreases exponentially as a function of the sub-range index i (i.e., the increment probability is 2⁻ⁱ for the iₜₕ sub-range).

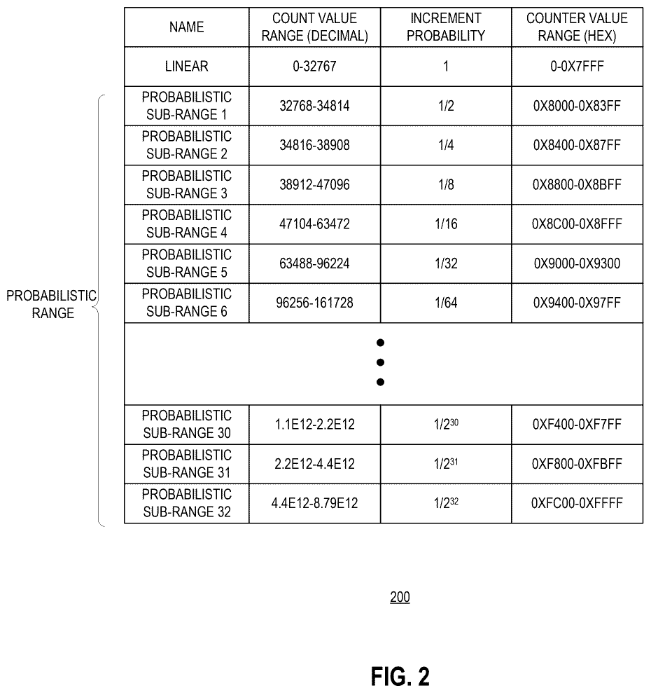

According to some aspects, the count value ranges may be assigned arbitrarily. FIG. 2 illustrates an example of the count value ranges, according to one aspect of the instant application. In the example shown in FIG. 2, Table 200 includes four columns. The first column corresponds to the name of each count value range or sub-range (e.g., linear range, probabilistic sub-range 1, probabilistic sub-range 2, etc.). The second column corresponds to the actual or estimated count values within each range or sub-range. The third column corresponds to the increment probability in each range or sub-range. For example, the increment probability in the linear range is 1, and the increment probability in the iₜₕ probabilistic sub-range is 2⁻ⁱ. The fourth column corresponds to the counter value in each range or sub-range. Note that the count values are the number of increment events being counted (expressed using a decimal representation), whereas the counter values represent the readings of the dual-scale counter (expressed using a hexadecimal representation). In the linear range, there is a one-to-one mapping between the count and counter values. However, in the probabilistic range, each counter value may represent a plurality of count values due to the increment probability being less than one.

In this example, a 16-bit counter may increment linearly (e.g., the counter may advance by one for each increment event) until it reaches a predetermined threshold value (e.g., 0x7FFF or nearly half its maximum value). The remaining half of the counter values (e.g., from 0x8000 to 0xFFFF) may be divided into 32 probabilistic sub-ranges, with the increment probability for each sub-range configured as 2⁻ⁱ, i=1, 2, . . . , 32. For example, once the counter advances from the linear range into probabilistic sub-range 1 (e.g., above 0x7FFF), the increment probability decreases to ½, meaning that there is 50% possibility that the counter would advance for each increment event. As the counter advances from one probabilistic sub-range to the next probabilistic sub-range, the increment probability is cut by half. The decreased increment probability means reduced counting accuracy. As discussed previously, such inaccuracies are acceptable for large count values.

Table 2 also indicates that the dual-scale counter may use a small number of bits (e.g., 16 bits) to count very large numbers (e.g., up to 8.79×10¹²). In contrast, a linear counter would need 48 bits to count such large numbers. Reducing the number of bits in a counter can reduce its chip area. More specifically, a typical counter circuit may include a plurality of cascaded flip-flop circuits, with each flip-flop circuit storing one bit. When the number of counter bits is reduced by two-thirds (e.g., from 48 to 16), the footprint of the counter may be reduced by two-thirds. Therefore, implementing dual-scale counters in network devices reduces part cost.

Various mechanisms may be used to determine the operating range (e.g., linear or probabilistic range) of a dual-scale counter while it is counting. According to some aspects, a table-lookup mechanism may be used to determine the current operating range of the counter. In one example, the system may perform a table lookup operation using Table 200 shown in FIG. 2. More specifically, the system may read the instant counter value and compare it with the counter value ranges/sub-ranges shown in the fourth column of Table 200. Once the counter value range/sub-range is determined, the system may determine the corresponding increment probability in the third column of Table 200. For example, if the instant counter value is 0x8811, the system can determine that the counter is operating in probabilistic sub-range 3, and the corresponding increment probability should be 2⁻³=⅛. In another example, the instant counter value is 0x95AF, the system can determine that the counter is operating in probabilistic sub-range 6, and the corresponding increment probability should be 2⁻⁶= 1/64.

According to some aspects, when operating in a probabilistic sub-range with a predetermined increment probability, the system may determine whether to increment the counter based on the output of a random number generator. According to further aspects, the random number generator may be implemented using a Linear-Feedback Shift Register (LFSR) that can output a random binary bit sequence comprising a plurality of bits. Depending on the increment probability, a subset of bits of the LFSR output will be evaluated. More specifically, a total of i bits of the LFSR output will be evaluated for an increment probability of 2⁻ⁱ. For example, in probabilistic sub-range 1 with an increment probability of ½, only one bit (e.g., bit 0) of the LFSR output will be evaluated to determine whether to increment the counter value. When an increment event is detected (e.g., an incoming packet matches a predetermined criterion), the system may determine whether bit 0 of the LFSR output is 1. If so, the counter increments; otherwise, the counter will not increment (i.e., the counter value remains unchanged). Similarly, in probabilistic sub-range 2 with an increment probability of ¼, two bits (e.g., bit 0 and bit 1) would be evaluated. For each increment event, the counter will increment if both bits are 1.

Other types of random number generators may also be used. In one example, the system may use a software-based random number generator to control the increment of the counter. For example, if the increment probability is 32, the random number generator may randomly generate a number between 0 and 31, and the counter will increment for an increment event if the randomly generated number matches a target number (e.g., 0).

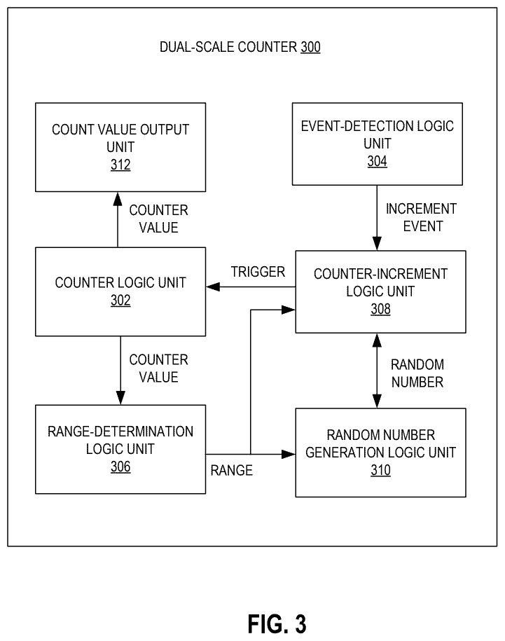

FIG. 3 illustrates the block diagram of an example dual-scale counter, according to one aspect of the instant application. In FIG. 3, a dual-scale counter 300 may include a counter logic unit 302, an event-detection logic unit 304, a range-determination logic unit 306, a counter-increment logic unit 308, a random-number-generation logic unit 310, and a counter value output unit 312. According to some aspects, dual-scale counter 300 may be part of a network device and can may be used to collect a certain type of network telemetry data. The various units within dual-scale counter 300 may be implemented using software components, hardware components, or a combination thereof.

Counter logic unit 302 may be used to count the number of occurrences of an event (e.g., the number of packets arrived at a port). Counter logic unit 302 may be implemented using different techniques (e.g., as a synchronous or asynchronous counter) and comprise various digital logic units (e.g., flip-flops). The scope of this disclosure is not limited by the actual implementation of counter logic unit 302.

Event-detection logic unit 304 is responsible for detecting an increment event. In the situation where dual-scale counter 300 is used for network telemetry purposes, event-detection logic unit 304 may detect an increment event by performing a match on one or more header fields of an incoming packet, including but not limited to source and destination Internet Protocol (IP) addresses, source and destination Media Access Control (MAC) addresses, source and destination port numbers (e.g., Transmission Control Protocol (TCP) and/or Universal Datagram Protocol (UDP) port numbers), virtual local area network (VLAN) tags, virtual network identifiers (VNIs), flow labels, differentiated services code point (DSCP) values, etc. In addition to network events (i.e., the transmitting and receiving of packets), depending on the use case, event-detection logic unit 304 may be used to detect other types of events that may trigger the increment of counter logic unit 302. The scope of this disclosure is not limited by the type of event detected by event-detection logic unit 304. Moreover, although shown as part of dual-scale counter 304, in some examples, event-detection logic unit 304 may be part of the packet-processing pipeline outside dual-scale counter 304.

Range-determination logic unit 306 is responsible for determining the operating range of dual-scale counter 300. According to some aspects, range-determination logic unit 306 may obtain the current counter value from counter logic unit 302 and determine the operating range accordingly. For example, range-determination logic unit 306 may determine that the operating range of dual-scale counter 300 is the linear range in response to the current counter value being smaller than a predetermined threshold. Range-determination logic unit 306 may further determine that the operating range is the probabilistic range in response to the current counter value being equal to or greater than the predetermined threshold. According to further aspects, the probabilistic range may be divided into a plurality of sub-ranges, and range-determination logic unit 306 may perform a table lookup to determine a particular probabilistic sub-range based on the current counter value. The lookup table can be similar to Table 200 shown in FIG. 2.

Counter-increment logic unit 308 is responsible for controlling the increment of counter logic unit 302. According to some aspects, counter-increment logic unit 308 may receive a signal from event-detection logic unit 304, indicating an increment event is detected. Counter-increment logic unit 308 may further receive the output of range-determination logic unit 306, indicating the operating range of dual-scale counter 300. If dual-scale counter 300 operates in the linear range, counter-increment logic unit 308 may send a trigger signal to counter logic unit 302, causing it to increment its value. In some examples, counter-increment logic unit 308 may increment the value of counter logic unit 302 by one for each increment event. In alternative examples, counter-increment logic unit 308 may increment the value of counter logic unit 302 by other positive values (e.g., two or three) for each increment event.

If dual-scale counter 300 operates in the probabilistic range, counter-increment logic unit 308 may obtain a random number generated by random-number-generation logic unit 310 and determine whether to send the trigger signal to counter logic unit 302 based on the random number. According to some aspects, random-number-generation logic unit 310 may include an LFSR that outputs a random binary bit sequence. Depending on the particular probabilistic sub-range in which dual-scale counter 300 operates, a subset of the bits of the LFSR output will be evaluated. More specifically, a total of i bits of the LFSR output will be evaluated when the current counter value belongs to the iₜₕ probabilistic sub-range. In one example, if all evaluated bits are “1,” counter-increment logic unit 308 may send the trigger signal to increment counter logic unit 302 for an increment event. In another example, if all evaluated bits are “0,” counter-increment logic unit 308 may send the trigger signal to increment counter logic unit 302 for an increment event. According to alternative aspects, random-number-generation logic unit 310 may include software components configured to generate a random number with a predetermined probability (e.g., 2⁻ⁱ). Counter-increment logic unit 308 may send the trigger signal to increment counter logic unit 302 for an increment event if the output of random-number-generation logic unit 310 matches a predetermined number (e.g., 0).

Count value output unit 312 is responsible for outputting the actual count of the increment events detected by event-detection logic unit 304 based on the counter value of counter logic unit 302. More specifically, count value output unit 312 may map the counter value to an actual or estimated count value. As discussed previously, when dual-scale counter 300 operates in the linear range, there is a one-to-one mapping between the counter value and the actual count value. On the other hand, when dual-scale counter 300 operates in the probabilistic range, each counter value may be mapped to a plurality of actual count values due to the uncertainty of the probability counter. In such a case, count value output unit 312 may estimate the actual count value based on the counter value.

According to some aspects, count value output unit 312 may use a lookup table (e.g., Table 200 shown in FIG. 2) to estimate the actual count value. For example, count value output unit 312 may determine the probabilistic sub-range corresponding to the counter value. Based on the determined sub-range, count value output unit 312 may determine the counter value lower bound of the sub-range, the count value lower bound of the sub-range (also referred to as a count-offset value), and the increment probability of the sub-range. Count value output unit 312 may then estimate the actual count value by computing the difference between the current counter value and the counter value lower bound of the sub-range, multiplying the difference by the inverse of the increment probability (which provides an estimated number of increment events counted within the probabilistic sub-range), and then adding the result of the multiplication to the count-offset value (i.e., the lower bound of the actual count value).

For example, if counter logic unit 302 outputs a counter value of 0x9009, which falls within probabilistic sub-range 5. Based on Table 200, count value output unit 312 may determine that, for probabilistic sub-range 5, the counter value lower bound is 0x9000, the count-offset value is 63488, and the increment probability is 1/32. Accordingly, count value output unit 312 may compute the difference between the current counter value and the lower bound of probabilistic sub-range 5 to get a number 9, which is the number of increments made by dual-scale counter 300 while operating in probabilistic sub-range 5. Count value output unit 312 may then multiply the number of increments (i.e., 9) by the inverse of the increment probability (i.e., 1/32), resulting in the estimated number of events counted (i.e., 288) when dual-scale counter 300 operates in probabilistic sub-range 5. Finally, count value output unit 312 may add 288 to 63488 (i.e., the lower bound of the actual count value of probabilistic sub-range 5) and output the result (i.e., 63776) as the estimation of the actual count value.

As discussed previously, compared to a linear counter that can output counting values in similar ranges, dual-scale counter 300 has a much smaller footprint because counter logic unit 302 includes significantly fewer flip-flop circuits than the linear counter. The only overhead in dual-scale counter 300 is random number generation logic unit 310, which is much smaller in comparison to the extra flip-flops circuits required by the linear counter.

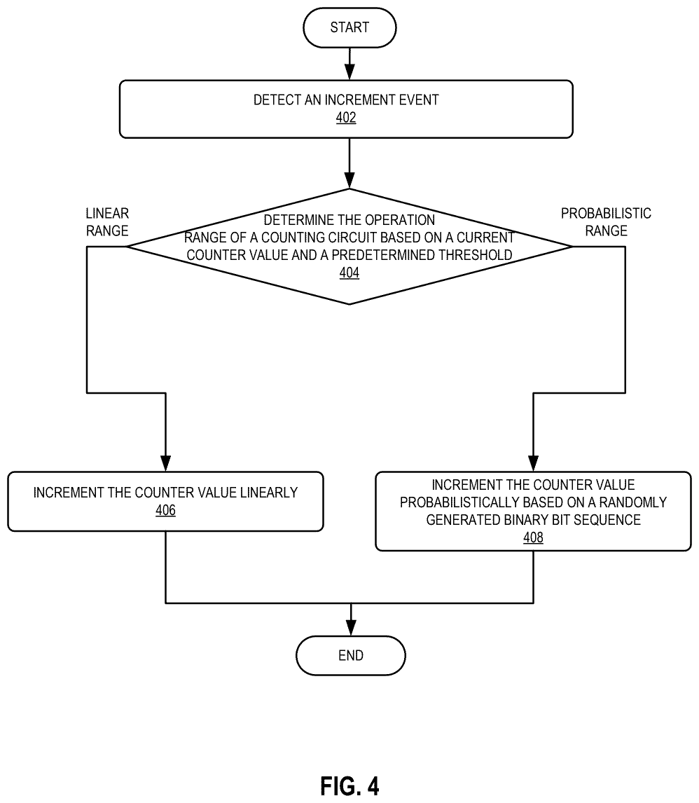

FIG. 4 presents a flowchart illustrating an example process for incrementing a dual-scale counter, according to one aspect of the instant application. Although FIG. 4 shows a specific order of operations, the methods are not limited to such order. For example, the operations shown in succession in the flowcharts may be performed in a different order, may be executed concurrently, or with partial concurrence or combinations thereof. During operation, the dual-scale counter may detect an increment event (operation 402). Depending on the use case, various logic units in a network device may detect the increment event. In one example, event-detection logic unit 304 shown in FIG. 3 may detect the increment event. In network telemetry applications, detecting the increment event may comprise performing a match on one or more header fields of an incoming packet.

The dual-scale counter may determine the operating range of a counting circuit based on a current counter value and a predetermined threshold value (operation 404). In some examples, the dual-scale counter may include a comparator circuit that compares the current counter value with the predetermined threshold. In some examples, the dual-scale counter may include a table-lookup logic unit that can look up a counter-value range table (e.g., Table 200 shown in FIG. 2) to determine the operating range of the counting circuit. The counting circuit may operate in a linear range or a probabilistic range. If the current counter value is smaller than the predetermined threshold, the counting circuit operates in the linear range. If the current counter value is equal to or larger than the predetermined threshold, the counting circuit operates in the probabilistic range. Moreover, the probability range may also be divided into a plurality of probabilistic sub-ranges. By comparing the current counter value with the lower and/or upper boundaries of each range and sub-range, the table-lookup logic unit may determine the operating range/sub-range of the counting circuit.

If the counting circuit is operating in the linear range, the counter value of the counting circuit may be incremented linearly for the increment event (operation 406). In one example, the counter value may increment by one for each increment event. In other examples, the counter value may be incremented by other positive numbers (e.g., two or three) for each increment event.

If the counting circuit is operating in the probabilistic range, the counter value of the counting circuit may be incremented probabilistically based on a randomly generated binary bit sequence for the increment event (operation 408). According to some aspects, the increment probability may be determined based on the probabilistic sub-range to which the current counter value belongs. More specifically, a higher counter value may result in a lower increment probability. Using Table 200 shown in FIG. 2 as an example, the increment probability for the iₜₕ probabilistic sub-range is 2⁻ⁱ, i=1, 2, . . . , 32. In addition to logarithmic base 2, the probabilistic range may be divided using another logarithmic basis, such as logarithmic base 10.

According to some aspects, the dual-scale counter may include an LFSR that can output a randomly generated binary bit sequence. Depending on the increment probability, a subset of the bits in the randomly generated binary bit sequence may be evaluated to determine whether to increment the counter value of the counting circuit. In one example, the counting circuit is incremented if all evaluated bits are “1” or “0.”

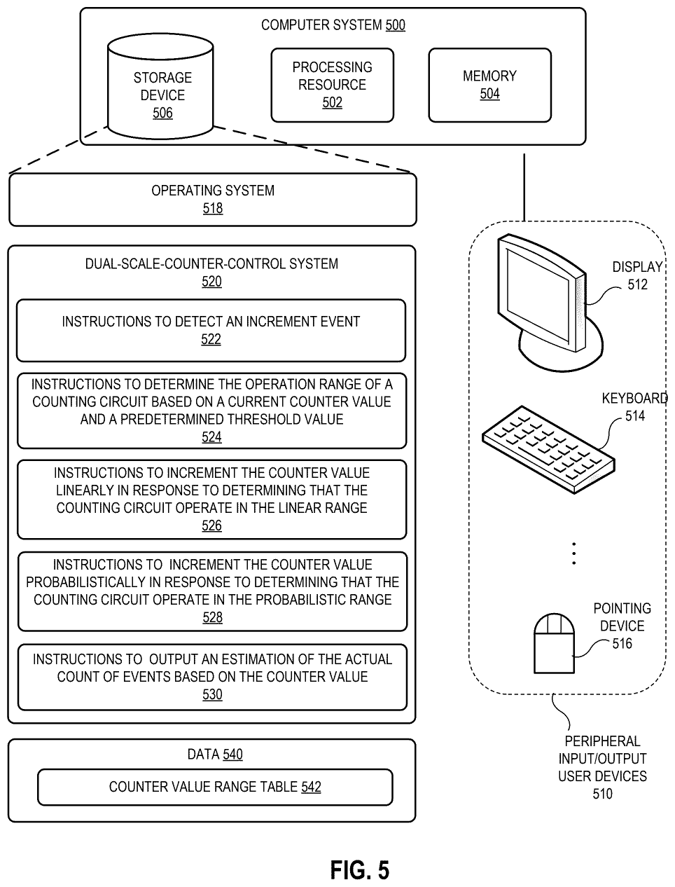

FIG. 5 illustrates a computer system that facilitates the operation of a dual-scale counter, according to one aspect of the instant application. Computer system 500 includes a processing resource 502, a memory 504, and a storage device 506. Furthermore, computer system 500 may be coupled to peripheral input/output (I/O) user devices 510 (e.g., a display device 512, a keyboard 514, and a pointing device 516). Storage device 506 includes a non-transitory computer-readable storage medium and stores an operating system 518, a dual-scale-counter-control system 518, and data 540. Computer system 500 may be implemented on a network device (e.g., a switch, a router, a network interface card (NIC), etc.) and may include fewer or more entities than those shown in FIG. 5.

In the examples described herein, the processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Dual-scale-counter-control system 520, which when executed by computer system 500 (or by processing resource 502 of computer system 500) may cause computer system 500 to perform methods and/or processes described in this disclosure. Specifically, dual-scale-counter-control system 520 may include instructions 522 to detect an increment event, as described above in relation to operation 402 shown in FIG. 4. According to some aspects, detecting the increment event may comprise performing a match on one or more header fields of an incoming packet.

Dual-scale-counter-control system 520 may include instructions 524 to determine the operating range of a counting circuit based on a current counter value and a predetermined threshold value, as described above in relation to operation 404 shown in FIG. 4. According to some aspects, determining the operating range of the counting circuit may comprise obtaining the current counter value and comparing it with the predetermined threshold. According to further aspects, determining the operating range of the counting circuit may comprise looking up a range table (e.g., Table 200 shown in FIG. 2).

Dual-scale-counter-control system 520 may include instructions 526 to increment the counter value linearly in response to determining that the counting circuit operates in the linear range, as described above in relation to operation 406 shown in FIG. 4. When operating in the linear range, the counter value may be incremented by a predetermined amount (e.g., by one) for each detected increment event.

Dual-scale-counter-control system 520 may include instructions 528 to increment the counter value probabilistically based on a randomly generated binary bit sequence in response to determining that the dual-scale event-counting circuit operates in the probabilistic range, as described above in relation to operation 408 shown in FIG. 4. When operating in the probabilistic range, for each increment event, the counter value may be incremented based on an increment probability corresponding to a probabilistic sub-range to which the current counter value belongs.

Dual-scale-counter-control system 520 may include instructions 530 to output an estimation of the actual count of events based on the counter value, as described above in relation to count value output unit 312 shown in FIG. 3.

Data 540 may include a counter value range table 542, as described above in relation to Table 200 shown in FIG. 2. Dual-scale-counter-control system 520 may include more instructions than those shown in FIG. 5. For example, Dual-scale-counter-control system 520 may also store instructions for generating a random binary bit sequence or a random number.

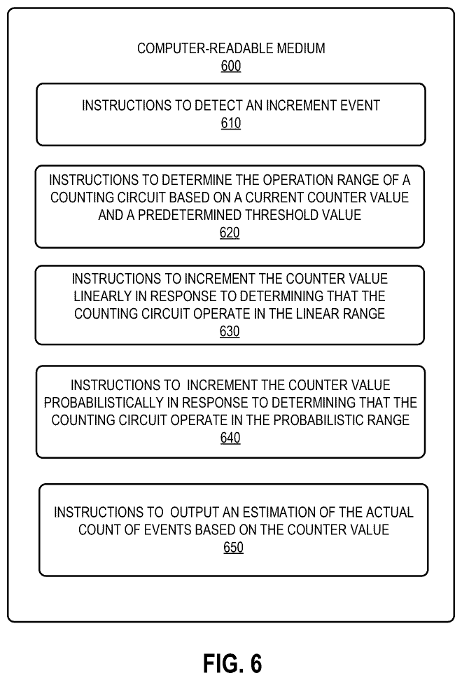

FIG. 6 illustrates a computer-readable medium that facilitates the operation of a dual-scale counter, according to one aspect of the instant application. CRM 600 may be a non-transitory computer-readable medium or device storing instructions that when executed by a computer or processing resource cause the computer or processing resource to perform a method.

CRM 600 may store instructions 610 to detect an increment event, as described above in relation to operation 402 shown in FIG. 4; instructions 620 to determine the operating range of a counting circuit based on a current counter value and a predetermined threshold value, as described above in relation to operation 404 shown in FIG. 4; instructions 630 to increment the counter value linearly in response to determining that the counting circuit operates in the linear range, as described above in relation to operation 406 shown in FIG. 4; instructions 640 to increment the counter value probabilistically based on a randomly generated binary bit sequence in response to determining that the dual-scale event-counting circuit operates in the probabilistic range, as described above in relation to operation 408 shown in FIG. 4; and instructions 650 to output an estimation of the actual count of events based on the counter value, as described above in relation to count value output unit 312 shown in FIG. 3.

CRM 600 may include more instructions than those shown in FIG. 6. For example, CRM 600 may also store instructions for generating a random binary bit sequence or a random number.

As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

In general, the disclosed aspects provide a dual-scale counter that can count small numbers accurately and large numbers approximately. When an increment event is detected, the counter-control logic can read the current counter value and determine the operating range of the counter based on the current counter value. If the current counter value is below a predetermined threshold, the counter operates in the linear range, and the counter-control logic can increment the counter linearly (e.g., the counter value is incremented by one for each event). If the current counter value is above the predetermined threshold, the counter operates in the probabilistic range, and the counter-control logic can increment the counter value based on a predetermined probability. The larger the counter value, the lower the increment probability. The counter-control logic may include an LFSR that can generate a pseudo-random sequence of binary bits and determine whether to increment the counter value based on a subset of bits output by the LFSR. The dual-scale counter has a much smaller footprint than linear counters with the same counting range and can accurately count small numbers.

One aspect of the instant application provides a dual-scale counter circuit that includes a counter logic unit to store a current counter value, a range-determination logic unit to determine an operating range of the dual-scale counter circuit based on the current counter value and a predetermined threshold value, and a counter-increment logic unit. The counter-increment logic unit is to increment the current counter value linearly for an increment event in response to the range-determination logic unit determining that the dual-scale counter circuit operates in a linear range and increment the current counter value probabilistically for the increment event in response to the range-determination logic unit determining that the dual-scale counter circuit operates in a probabilistic range. The dual-scale counter circuit further includes a linear-feedback shift register to generate a random binary bit sequence, based on which the counter-increment logic unit is to determine whether to increase the current counter value for the increment event when the dual-scale counter circuit operates in the probabilistic range.

In a variation on this aspect, the range-determination logic unit is further to determine that the dual-scale counter circuit operates in the linear range in response to the current counter value being smaller than the predetermined threshold value and determine that the dual-scale counter circuit operates in the probabilistic range in response to the current counter value being equal to or larger than the predetermined threshold value.

In a variation on this aspect, the range-determination logic unit may include a table-lookup logic unit to look up a counter value range table based on the current counter value.

In a further variation, the counter value range table may include a plurality of rows, each row corresponding to a counter value range with a range starting value, a range ending value, and a probability for incrementing the current counter value for the increment event.

In a further variation, the probability may decrease as the current counter value increases from a first counter value range to a second counter value range.

In a further variation, the probability may decrease exponentially according to a power of two.

In a further variation, the dual-scale counter circuit may include a count value output unit to output an estimation of a total count of increment events based on the current counter value and the counter value range table. The dual-scale counter has a smaller footprint compared to a linear counter that outputs the total count of increments events.

In a further variation, each row may further specify a count-offset value for the counter value range. The count value output unit may determine, from the plurality of rows, a row corresponding to the counter value range to which the current counter value belongs; subtract the range-starting value specified by the determined row from the current counter value to obtain a number of increments made within the counter value range; multiply the number of increments by an inverse of the probability specified by the determined row to obtain an estimated number of increment events counted within the counter value range; and add the count-offset value specified by the determined row to the estimated number of increment events.

In a variation on this aspect, the random binary bit sequence may include a plurality of bits, and the counter-increment logic may evaluate a subset of the bits based on a probabilistic sub-range corresponding to the current counter value.

In a further variation, the counter-increment logic unit may increment the current counter value if all bits in the subset are set as one.

One aspect of the instant application provides a system and method for incrementing a dual-scale counter circuit. During operation, the system may detect an increment event, determine an operating range of a dual-scale counter circuit based on a current counter value and a predetermined threshold value, increment the current counter value linearly in response to determining that the dual-scale counter circuit operates in a linear range, and incrementing the current counter value probabilistically based on a randomly generated binary bit sequence in response to determining that the dual-scale counter circuit operates in a probabilistic range.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A dual-scale counter circuit, comprising:
a counter logic unit to store a current counter value;
a range-determination logic unit to determine an operating range of the dual-scale counter circuit based on the current counter value and a predetermined threshold value;
a counter-increment logic unit to:
increment the current counter value linearly for an increment event in response to the range-determination logic unit determining that the dual-scale counter circuit operates in a linear range; and
increment the current counter value probabilistically for the increment event in response to the range-determination logic unit determining that the dual-scale counter circuit operates in a probabilistic range; and
a linear-feedback shift register to generate a random binary bit sequence, based on which the counter-increment logic unit is to determine whether to increase the current counter value for the increment event when the dual-scale counter circuit operates in the probabilistic range.

2. The dual-scale counter circuit of claim 1, wherein the range-determination logic unit is further to:
determine that the dual-scale counter circuit operates in the linear range in response to the current counter value being smaller than the predetermined threshold value; and
determine that the dual-scale counter circuit operates in the probabilistic range in response to the current counter value being equal to or larger than the predetermined threshold value.

3. The dual-scale counter circuit of claim 1, wherein the range-determination logic unit comprises a table-lookup logic unit to look up a counter value range table based on the current counter value.

4. The dual-scale counter circuit of claim 3, wherein the counter value range table comprises a plurality of rows, each row corresponding to a counter value range with a range starting value, a range ending value, and a probability for incrementing the current counter value for the increment event.

5. The dual-scale counter circuit of claim 4, wherein the probability decreases as the current counter value increases from a first counter value range to a second counter value range.

6. The dual-scale counter circuit of claim 5, wherein the probability decreases exponentially according to a power of two.

7. The dual-scale counter circuit of claim 4, further comprising a count value output unit to output an estimation of a total count of increment events based on the current counter value and the counter value range table, wherein the dual-scale counter has a smaller footprint compared to a linear counter that outputs the total count of increments events.

8. The dual-scale counter circuit of claim 7, wherein each row further specifies a count-offset value for the counter value range, the count value output unit is to:
determine, from the plurality of rows, a row corresponding to the counter value range to which the current counter value belongs;
subtract the range-starting value specified by the determined row from the current counter value to obtain a number of increments made within the counter value range;
multiply the number of increments by an inverse of the probability specified by the determined row to obtain an estimated number of increment events counted within the counter value range; and
add the count-offset value specified by the determined row to the estimated number of increment events.

9. The dual-scale counter circuit of claim 1, wherein the random binary bit sequence comprises a plurality of bits, and wherein the counter-increment logic is to evaluate a subset of the bits based on a probabilistic sub-range corresponding to the current counter value.

10. The dual-scale counter circuit of claim 9, wherein the counter-increment logic unit is to increment the current counter value if all bits in the subset are set as one.

11. A method, comprising:
detecting an increment event;
determining an operating range of a dual-scale counter circuit based on a current counter value and a predetermined threshold value;
incrementing the current counter value linearly in response to determining that the dual-scale counter circuit operates in a linear range; and
incrementing the current counter value probabilistically based on a randomly generated binary bit sequence in response to determining that the dual-scale counter circuit operates in a probabilistic range.

12. The method of claim 11, comprising:
determining that the dual-scale counter circuit operates in the linear range in response to the current counter value being smaller than the predetermined threshold value; and
determining that the dual-scale counter circuit operates in the probabilistic range in response to the current counter value being equal to or larger than the predetermined threshold value.

13. The method of claim 11, further comprising looking up a counter value range table based on the current counter value, the counter value range table comprising a plurality of rows, each row corresponding to a counter value range with a range starting value, a range ending value, and a probability for incrementing the current counter value for the increment event.

14. The method of claim 13, wherein the probability decreases as the current counter value increases from a first counter range to a second counter value range.

15. The method of claim 14, wherein the probability decreases exponentially according to a power of two.

16. The method of claim 13, further comprising estimating a total count of increment events based on the current counter value and the counter value range table.

17. The method of claim 16, wherein each row further specifies a count-offset value for the counter value range, and wherein estimating the total count of increment events comprises:
determining, from the plurality of rows, a row corresponding to the counter value range to which the current counter value belongs;
subtracting the range-starting value specified by the determined row from the current counter value to obtain a number of increments made within the counter value range;
multiplying the number of increments by an inverse of the probability specified by the determined row to obtain an estimated number of increment events counted within the counter value range; and
adding the count-offset value specified by the determined row to the estimated number of increment events.

18. The method of claim 11, wherein the random binary bit sequence comprises a plurality of bits, and wherein incrementing the current counter value probabilistically comprises evaluating a subset of the bits based on a probabilistic sub-range corresponding to the current counter value.

19. A non-transitory machine-readable storage medium storing instructions executable by a processing resource to:
detect an increment event;
determine an operating range of a dual-scale counter circuit based on a current counter value and a predetermined threshold value;
increment the current counter value linearly in response to determining that the current counter value is smaller than the predetermined threshold value; and
increment the current counter value probabilistically based on a randomly generated binary bit sequence in response to determining that the current counter value is equal to or larger than the predetermined threshold value.

20. The non-transitory machine-readable storage medium of claim 19, the instructions are further to look up a counter value range table based on the current counter value, the counter value range table comprising a plurality of rows, each row corresponding to a counter value range with a range starting value, a range ending value, and a probability for incrementing the current counter value for the increment event.
